(19) United States
(12) Patent Application Publication
(10) Pub. No.: US 2019/0041653 A1
(43) Pub. Date: Feb. 7, 2019

(54) DEVICE FOR COMPACTING DUAL LASER BEAMS

(71) Applicant: CHRISTIE DIGITAL SYSTEMS USA, INC., Cypress (CA)

(72) Inventors: Oscar YEUNG, Waterloo (CA); Dennis MILNE, Cambridge (CA); Mang LI, Waterloo (CA)

(21) Appl. No.: 15/669,057

(22) Filed: Aug. 4, 2017

(51) Int. Cl. G02B 27/10; G02B 27/14; G02B 27/09; H04N 9/31

(52) U.S. Cl. CPC G02B 27/106; G02B 27/144; H04N 9/3164; G02B 27/148; H04N 9/3129; G02B 27/0977

(57) ABSTRACT

A device for compacting dual laser beams is provided. The device comprises: a laser device configured to emit a first laser beam and a second laser beam in a first direction; and a mirror comprising a transparent body including: a front surface including a front reflective region and a front transmissive region; and a rear surface about parallel to the front surface, the rear surface comprising a rear reflective region, the regions arranged, relative to the laser device such that: the front reflective region is configured to reflect the first laser beam from the front surface in a second direction, the front transmissive region is configured to transmit the second laser beam therethrough, and the rear reflective region is configured to reflect the second laser beam, as transmitted through the front transmissive region, back through the front transmissive region in the second direction.

### FIELD

The specification relates generally to optical devices, and specifically to a device for compacting dual laser beams.

### BACKGROUND

Laser devices are sometimes supplied with two output laser beams with fixed output emitter distances. Multiple pairs of these devices may be grouped together to build a laser optical sub-assembly (LOS). Mirrors are used to steer and direct the two laser beams to reduce the collimated spot size footprint and guiding beam propagation for optical power coupling, in a ratio of one mirror per laser beam. However, there is a significant cost and complexity of using one mirror per laser beam to direct a beam within a LOS. It is difficult and costly to use tiny individual mirrors that are mounted very close to each other.

### SUMMARY

An aspect of the specification provides a device comprising: a laser device configured to emit a first laser beam and a second laser beam, about parallel to the first laser beam, the first laser beam and the second laser beam emitted in a first direction; and a mirror comprising a transparent body including: a front surface including a front reflective region and a at least one front transmissive region; and a rear surface about parallel to the front surface, the rear surface comprising a rear reflective region, the front reflective region, the at least one front transmissive region and the rear reflective region arranged, relative to the laser device such that: the front reflective region is configured to reflect the first laser beam from the front surface in a second direction, the at least one front transmissive region is configured to transmit the second laser beam therethrough, and the rear reflective region is configured to reflect the second laser beam, as transmitted through the at least one front transmissive region, back through the at least one front transmissive region in the second direction.

In this specification, elements may be described as “configured to” perform one or more functions or “configured for” such functions. In general, an element that is configured to perform or configured for performing a function is enabled to perform the function, or is suitable for performing the function, or is adapted to perform the function, or is operable to perform the function, or is otherwise capable of performing the function.

It is understood that for the purpose of this specification, language of “at least one of X, Y, and Z” and “one or more of X, Y and Z” can be construed as X only, Y only, Z only, or any combination of two or more items X, Y, and Z (e.g., XYZ, XY, YZ, ZZ, and the like). Similar logic can be applied for two or more items in any occurrence of “at least one . . . ” and “one or more . . . ” language.

The terms “about”, “substantially”, “essentially”, “approximately”, and the like, are defined as being “close to”, for example as understood by persons of skill in the art. In some implementations, the terms are understood to be “within 10%,” in other implementations, “within 5%”, in yet further implementations, “within 1%”, and in yet further implementations “within 0.5%”.

### BRIEF DESCRIPTIONS OF THE DRAWINGS

For a better understanding of the various implementations described herein and to show more clearly how they may be carried into effect, reference will now be made, by way of example only, to the accompanying drawings in which:

FIG. 1 depicts a device for directing two laser beams using two mirrors, according to the prior art.

FIG. 2 depicts a side schematic view of a device for compacting two laser beams using two mirrors, according to non-limiting implementations.

FIG. 3 depicts detail of a region of the device of FIG. 2, as well as geometry of the device of FIG. 2, according to non-limiting implementations.

FIG. 4 depicts a side schematic view of an alternative device for compacting two laser beams using two mirrors, according to non-limiting implementations.

FIG. 5 depicts a front surface view of a mirror of the device of FIG. 4., according to non-limiting implementations.

FIG. 6 depicts a side schematic view of yet a further alternative device for compacting two laser beams using two mirrors, according to non-limiting implementations.

FIG. 7 depicts a device assembled from a plurality of the devices of FIG. 2, according to non-limiting implementations.

### DETAILED DESCRIPTION

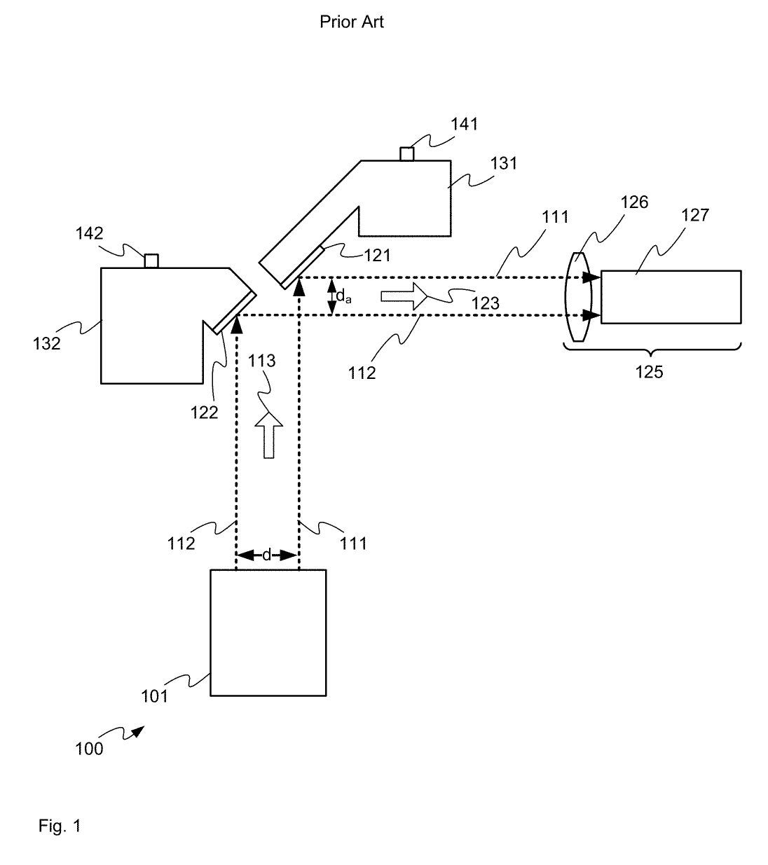

Attention is first directed to FIG. 1 which depicts a schematic side view of a device 100 of prior art systems; the device 100 comprises a laser device 101 configured to emit a first laser beam 111 and a second laser beam 112, about parallel to the first laser beam 111, the first laser beam 111 and the second laser beam 112 emitted in a first direction 113. The respective paths of the laser beams 111, 112 are depicted in broken lines. Furthermore, each of the laser beams 111, 112 may generally be a same color, such as green.

The device 100 further comprises mirrors 121, 122. The mirrors 121, 122 are respectively located along a path of the first laser beam 111 and the second laser beam 112, the mirror 121 configured to reflect the first laser beam 111 in a second direction 123, and the mirror 122 configured to reflect the second laser beam 112 in the second direction 123. For example, the second direction 123 is about perpendicular to the first direction 113. In other words, the mirrors 121, 122 are generally configured to redirect the laser beams 111, 112 from the first direction 113 to the second direction 123.

As depicted, the laser beams 111, 112 are a fixed perpendicular distance “d” apart (e.g. a shortest distance between the laser beams 111, 112 and/or a distance between the laser beams 111, 112 when a perpendicular line is drawn therebetween and/or an output emitter distance) and about parallel to each other. The mirrors 121, 122 hence generally redirect the laser beams 111, 112 through about a 90° angle, and hence each of the mirrors 121, 122 are at about a 45° angle to a respective laser beam 111, 112. In other words, the second direction 123 is at about a 90° angle to the first direction 113. The laser beams 111, 112 are generally reflected towards optics 125 including, but not limited to, collimating optics and/or integrating optics and the like, of a projector such as lenses (e.g. as indicated by an example lens 126), integrating rods (e.g. as indicated by an example integrating rod 127), and the like.

Hence, the mirrors, 121, 122 are located as close together as possible to decrease the distance between the laser beams 111, 112 upon reflection in order to reduce a collimated spot size footprint as the laser beams 111, 112 interact with the optics 125. However, as the mirrors 121, 122 are close together, it is challenging to use automated grips to position them. Hence, the mirrors 121, 122 are attached to respective brackets 131, 132, each bracket 131, 132 having a respective grip 141, 142 (e.g. a protrusion and the like) that can be gripped and manipulated to move the brackets 131, 132 to, in turn position, the mirrors 121, 122 to decrease the distance between the laser beams 111, 112 upon reflection. However, the brackets 131, 132 are bulky, and hence it is difficult to effectively position the mirrors 121, 122, which may result in a distance da between the laser beams 111, 112 upon reflection, being larger than desired and/or incompatible with the optics 125 and/or may result in a collimated beam size that leads to artifacts and/or hotspots and/or irregularities in projected images.

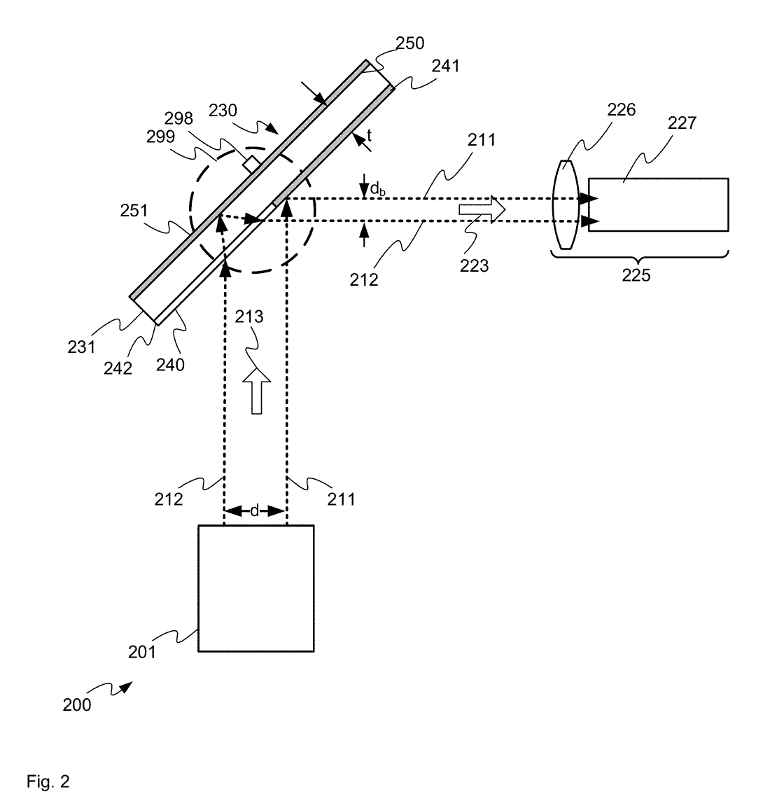

Hence, attention is next directed to FIG. 2 which depicts a schematic side view of a device 200 comprising a laser device 201 configured to emit a first laser beam 211 and a second laser beam 212, about parallel to the first laser beam 211, the first laser beam 211 and the second laser beam 212 emitted in a first direction 213. Furthermore, the laser beams 211, 212 are a fixed perpendicular distance “d” apart from each other. Hence, the laser device 201 is similar to the laser device 101. The respective paths of the laser beams 211, 212 are depicted in broken lines.

In some implementations, the laser device 201 is generally configured to emit a single color and/or wavelength of laser beam, for example green. Indeed, laser devices emitting green laser beams are often provided in such a dual laser beam configuration. However, the laser device 201 may emit other colours, including, but not limited to, blue and red. Furthermore, while it is assumed herein that each of the laser beams 211, 212 are the same colour, in other implementations, the laser beams 211, 212 may be different colours and/or wavelengths. Furthermore, the color(s) and/or wavelength(s) emitted of the laser beams 211, 212 emitted by the device 201 may be visible to a human vision system (e.g. a human being and/or a machine vision system that is configured to detect like similar to a human being) or invisible to a human vision system and may include wavelengths in one or more of visible range, an infrared range and an ultraviolet range.

Regardless, the device 200 is generally configured to reflect and/or redirect the laser beams 211, 212 such that, upon reflection, the laser beams 211, 212 are closer together than the distance “d”.

Hence, the device 200 further comprises a mirror 230 configured to reflect and/or redirect each of the laser beams 211, 212 in a second direction 223, for example to optics 225 similar to the optics 125, including, but not limited to, collimating optics and/or integrating optics and the like, of a projector such as lenses (e.g. as indicated by an example lens 226), integrating rods (e.g. as indicated by an example integrating rod 227), and the like. It is appreciated, however, that the optics 225 do not form part of the device 100.

However, in contrast to the device 100, which includes two separate mirrors 121, 122, the mirror 230 comprises a transparent body 231 including: a front surface 240 including a front reflective region 241 and a front transmissive region 242; and a rear surface 250 about parallel to the front surface 240, the rear surface 250 comprising a rear reflective region 251. The transparent body 231 generally has a thickness “t” and comprises an optical material that is transparent to at least the first laser beam 211 including, but not limited to, glass, quartz, optical plastic, and the like.

As depicted, a respective thickness of each of the regions 241, 242, 251 are exaggerated. For example, each of the front reflective region 241 and the rear reflective region 251 each comprises a reflective coating, for example, a vacuum deposited layer of reflective material (e.g. metal, and the like). Similarly, the front transmissive region 242 may include an anti-reflective coating that is specifically configured to transmit the laser beam 211 at the incident angle. However, the front transmissive region 242 may alternatively be free of coatings and the front transmissive region 242 may comprise the material of the transparent body 231. Regardless, the respective thicknesses of each of the regions 241, 242, 251 is generally small and/or negligible as compared to the thickness “t” of the transparent body 231.

The front reflective region 241, the front transmissive region 242 and the rear reflective region 251 are generally arranged, relative to the laser device 201, such that: the front reflective region 241 is configured to reflect the first laser beam 211 from the front surface 240 in the second direction 223; the front transmissive region 242 is configured to transmit the second laser beam 212 therethrough; and the rear reflective region 251 is configured to reflect the second laser beam 212, as transmitted through the front transmissive region 242, back through the front transmissive region 242 in the second direction 223.

In other words, the front surface 240 of the mirror 230 reflects the first laser beam 211 from the first direction 213 to the second direction 223, and the rear surface 250 of the mirror 230 reflects the second laser beam 212 from the first direction 213 to the second direction 223, the second laser beam 212 passing through front transmissive region 242 through the transparent body 231 to reflect from the rear reflective region 251 back through the front transmissive region 242.

Also depicted in FIG. 2, refraction occurs at each instance of the second laser beam 212 entering and exiting the transparent body 231; furthermore, each of the instances of refraction are complementary such that that the second laser beam 212 is reflected in the second direction 223 after interacting with the mirror 230.

In other words, as the front surface 240 and the rear surface 250 are generally parallel, and as laser beams 211, 212 are also generally parallel, each of the laser beams 211, 212 are reflected through the same angle towards the second direction 223 (e.g. as the refraction of the laser beam 212 entering and exiting the transparent body 231 are complementary).

Hence, comparing the devices 100, 200, the two mirrors 121, 122 of the device 100 are replaced in the device 200 by a single integrated mirror 230 which reflects both of the laser beams 211, 212, one from the front surface 240 and one from the rear surface 250.

Hence, for example, using a grip 298, an angle and/or position of the entire mirror 230 may be adjusted using, for example, an automatic positioner, and the like, which can be more versatile than using the brackets 131, 132 to adjust the individual mirrors 121, 122. Furthermore, by eliminating the brackets 131, 132, the device 200 has a smaller physical footprint than the device 100.

In addition, while the depicted length of the mirror 230 extends a distance away from points where each of the laser beams 211, 212 interact with the mirror 230, the mirror 230 may be more compact than as depicted, for example ends of the mirror 230 being adjacent to the points where each of the laser beams 211, 212 interact with the mirror 230, for example with a region 299 and the like. Indeed, the length and/or width of the mirror 230 may each be only large enough to ensure that light from each of the laser beams 211, 212 is reflected as described herein. Indeed, while the mirror 230 is depicted only from one side (e.g. from an edge), the mirror 230 can be any shape including, but not limited to, rectangular, square, circular, oval, etc.

In general, the mirror 230 (e.g. the front surface 240 and the rear surface 250) is at a given angle relative to respective paths of each of the first laser beam 211 and the second laser beam 212, for example, as depicted, about 45°.

Furthermore, the thickness “t” of the transparent body 231, as well as the positions of the regions 241, 242, 251, are selected to minimize and/or reduce a distance “d_{b}” between the laser beams 211, 212 upon reflection to the second direction 223, as compared to one or more of the distance “dₐ” of the device 100 and/or the distance “d”.

For example, the front reflective region 241, the front transmissive region 242, and the rear reflective region 251 may be further configured to: reflect the second laser beam 212 back through the front transmissive region 242 adjacent the front reflective region 241. Similarly, the front reflective region 241 and the front transmissive region 242 may be further configured to: reflect the first laser beam 211 adjacent the front transmissive region 242.

Put another way, the positions of the front reflective region 241, the front transmissive region 242, and the rear reflective region 251, as well as the thickness “t” of the transparent body 231, are generally selected such that the front reflective region 241 does not reflect and/or interfere with the second laser beam 212 (e.g. the second laser beam 212 clears and/or does not interact with the front reflective region 241) and the distance “d_{b}” between the laser beams 211, 212 upon reflection to the second direction 223 is compatible with the optics 225 (e.g. the distance “d_{b}” between the laser beams 211, 212 upon reflection to the second direction 223 is compatible with a given collimated spot size footprint).

Hence, in general, the front transmissive region 242 is closer to the laser device 201 than the front reflective region 241. Furthermore, the thickness “t” is selected to ensure that the second laser beam 212 clears and/or does not interact with the front reflective region 241, and furthermore to control the distance “d_{b}”. In some implementations, the distance “db” may be selected to be less than the distance “dₐ”, however the distance “db” may be selected to be any distance compatible with the geometry of the mirror 203 as described below.

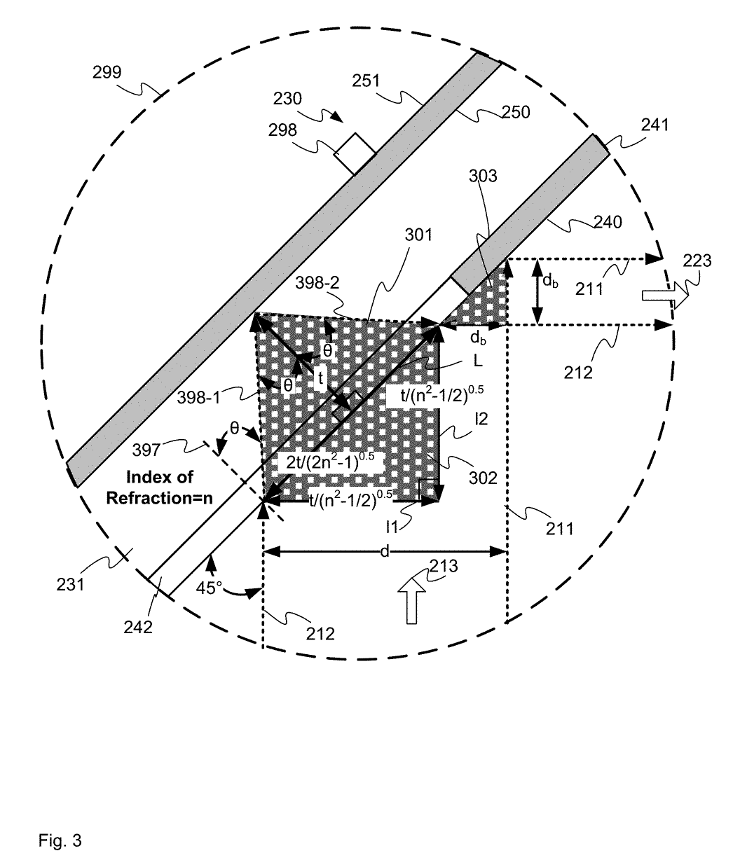

Attention is next directed to FIG. 3 which depicts detail of a region 299 of FIG. 2 that includes the points were the first laser beam 211 reflects from the front reflective regions 241 and the points where the second laser beam 212: enters the transparent body 231 through the front transmissive region 242, reflects from the rear reflective region 251, and exits the transparent body 231 through the front transmissive region 242. It is further assumed in FIG. 3 that the mirror 230 is at about 45° relative to respective paths of each of the first laser beam 211 and the second laser beam 212. In FIG. 3, a simple model of the geometry of the laser beams 211, 212 is shown, assuming that the incident angle for the laser beam 212 into the transparent body 231 is 45°, the index of refraction of the transparent body 231 is “n” (e.g. about 1.47 in implementations where the transparent body 231 is glass), and an index of refraction for the environment between the laser device 201 and the mirror 230 is assumed to be ″1. Hence, the second laser beam 212 diffracts according to Snell's law where the angle of refraction θ (e.g. from a normal 397 to the front surface 240) is defined by sin θ=1/(n\sqrt{7}).

Hence, from FIG. 3, it is apparent that an isosceles triangle 301 is formed by: two segments 398-1, 398-2 of the path of the second laser beam 212 through the transparent body 231, which form respective two legs of the isosceles triangle 301); and a line “L” connecting the points where the second laser beam 212 enters the transparent body 231 and exits the transparent body 231 (e.g. which forms an hypotenuse of the isosceles right-angle triangle 301). The height of the isosceles triangle 301 is the thickness “t” of the transparent body 231), and assuming that the refraction angle is defined by sin θ=1/(n\sqrt{2}), from geometry of isosceles triangles, the line “L” has a length “2t/\sqrt{2n²−1}”.

For example, with reference to FIG. 3, the vertex angle of the isosceles triangle 301 is 2θ, and the isoceles triangle 301 may be split into two right triangles with each having a respective hypotenuse formed by a respective segment 398-1, 398-2. Given that sine is defined by “opposite over hypotenuse”, and given the Pythagorean Theorem:

$$sin θ = 1 / ( n \sqrt{2} = ( L / 2 ) / \sqrt{{( \frac{L}{2} )}^{2} + {t}^{2}} \qquad Equation ( 1 )$$

In Equation (1), L is the length of the base of the isosceles triangle 301, n is the index of refraction of the transparent body 231, and t is the thickness of the transparent body 231.

Solving Equation (1) for L results in:

L=2t/\sqrt{2n²−1} Equation (2)

The base of the isosceles triangle 301 further forms the base of an isosceles right-angle triangle 302 having legs 11, 12, with the leg 11 being perpendicular the laser beams 211, 212, and the leg 12 being and parallel to the laser beams 211, 212. The perpendicular leg 11 extends from the point where the second laser beam 212 enters the transparent body 231, and the parallel leg 12 extends from the point where the second laser beam 212 exits the transparent body 231.

Furthermore, as the isosceles right-angle triangles 302 may be split into two right triangles, each having a respective hypotenuse 11 and 12 (e.g. the legs of an isosceles right-angle triangle form respective hypotenuses of two right angle triangles), and each respective leg of each of the right-angle triangles is L/2, then, from the Pythagorean Theorem:

l1²=l2²=2(L/2)² Equation (3)

And hence each of 11 and 12 are defined by:

$$I 1 = I 2 = t / \sqrt{{n}^{2} - \frac{1}{2}} \qquad Equation ( 4 )$$

Hence, in order for the second laser beam 212 to not interact with the front reflective region 241, an edge of the front reflective region 241that closest to the point where the second laser beam 212 exits the transparent body 231, is greater than the distance

$$“ t / \sqrt{{n}^{2} - \frac{1}{2}} ”$$

from the point where the second laser beam 212 enters the transparent body 231.

In addition a second isosceles right-angle triangle 303 is formed by: the distance “d_{b}” between the laser beams 211, 212 upon reflection in the second direction 223 (which forms a first leg); the shortest distance between the point where the second laser beam 212 exits the transparent body 231 and the first laser beam 211 (which forms the second leg, and is hence also the distance “d_{b}”); and the distance between the point where the second laser beam 212 exits the transparent body 231 and the point where the first laser beam 211 reflects from the front reflective region 241 (which forms the hypotenuse).

Further, the two triangles 302, 303 share the point where the second laser beam 212 exits the transparent body 231. Hence, using geometry, and from FIG. 3:

$$d = {d}_{b} + t / \sqrt{{n}^{2} - \frac{1}{2}} \qquad Equation ( 5 )$$

Put another way, a distance between the point where the second laser beam 212 exits the transparent body 231 and the path of the first laser beam 211 is a distance

$$t / \sqrt{{n}^{2} - \frac{1}{2}} ,$$

which is equivalent to the distance “d_{b}”, and/or:

$${d}_{b} = d - t / \sqrt{{n}^{2} - \frac{1}{2}} \qquad Equation ( 6 )$$

Hence, when the mirror 230 is at about 45° relative to respective paths of each of the first laser beam 211 and the second laser beam 212, and assuming a minimum distance of d_{b} of “0”:

$$t < d \sqrt{{n}^{2} - \frac{1}{2}} \qquad Equation ( 7 )$$

In Equation (7), t is the thickness of the transparent body 231, d is the perpendicular distance between the first laser beam 211 and the second laser beam 212, and n is the index of refraction of the transparent body 231. In other words, once the distance “d” is known, the thickness “t” of the transparent body 231 (and/or the mirror 230) is selected to be

$$d \sqrt{{n}^{2} - \frac{1}{2}}$$

so that db has a positive value (e.g. according to Equation (6).

For example, if the transparent body 231 is made from borosilicate glass having an index of refraction of 1.47, then t can be set to less than 1.288 d, solving Equation (7).

Hence, prior to assembling the device 200, assuming that the mirror 230 is to be at about 45° relative to respective paths of each of the first laser beam 211 and the second laser beam 212, once the distance “d” is determined, for example from a specification of the device 200, the thickness “t” of the transparent body 231 of the mirror 230 is selected to be less than

$$d \sqrt{{n}^{2} - \frac{1}{2}} .$$

However, often laser devices, similar to the laser device 201, are provided from a manufacturer with the two laser beams being not exactly parallel and/or divergent, and/or the laser beams having an angular spread and/or etendue. Hence, the thickness “t” may be selected to ensure that light from the first laser beam 211 does not spill into the front reflective region 241 and similarly to ensure that light from the second laser beam 212 does not interact with the front reflective region 241, either upon entering or exiting the front transmissive region 242.

Similarly, the angle that the mirror 230 forms with the laser beams 211, 212 need not be 45° and indeed, the angle of the mirror 230 may be adjustable using the grip 298. For example, the mirror 230 may be installed at 45°, or another angle, and the angle may be adjusted (manually and/or automatically) using grip 298 until the laser beams 211, 212, upon reflection from the mirror 230, adequately interact with the optics 225.

For example, the device 200 may be a component of a laser optical sub-assembly (LOS) which is to be installed in a projector and/or a light assembly that provides light for a projector. Once the LOS is installed with the device 200, the angle of the mirror 230 may be adjusted until an image produced by the projector, using at least in part the laser beams 211, 212, is optimized, and/or until a collimated spot size footprint is optimized and/or minimized. However, the mirror 230 may alternatively be adjusted prior to installation of the LOS at a projector, for example according to a given optimal collimated spot size footprint specified by a manufacturer of the projector.

Furthermore, by using one mirror 230 for the two laser beams 211, 212, a number of mirrors used to direct the laser beams 211, 212 is reduced by half. In some light assemblies, there may be tens to hundreds of devices similar to the device 100, hence, by replacing the device 100 with the device 200 in light assemblies, the number of mirrors used in the light assembly (e.g. for green light) may be significantly reduced, which may further reduce set-up time.

While the front reflective region 241 is depicted as covering about half of the front surface 240, and the rear reflective region 251 is depicted as covering the entirety of the rear surface 250, each of the front reflective region 241 and the rear reflective region 251 may be located only at an area of a respective surface 240, 250 that will cause the respective laser beams 211, 212 to be reflected. Similar, an antireflective coating of the front transmissive region 242 may be located only at areas of the front surface 240 where the second laser beam 212 is transmitted.

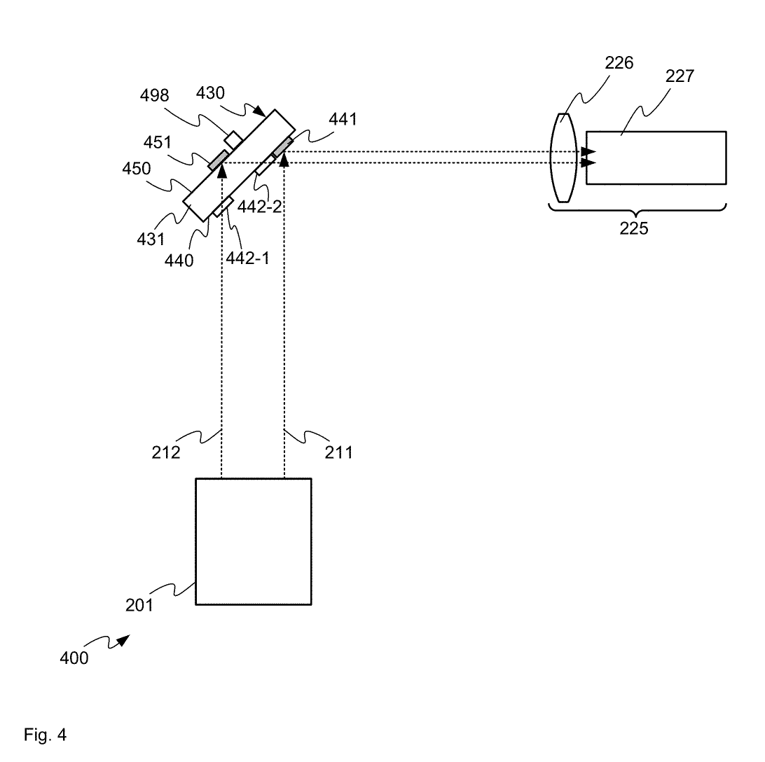

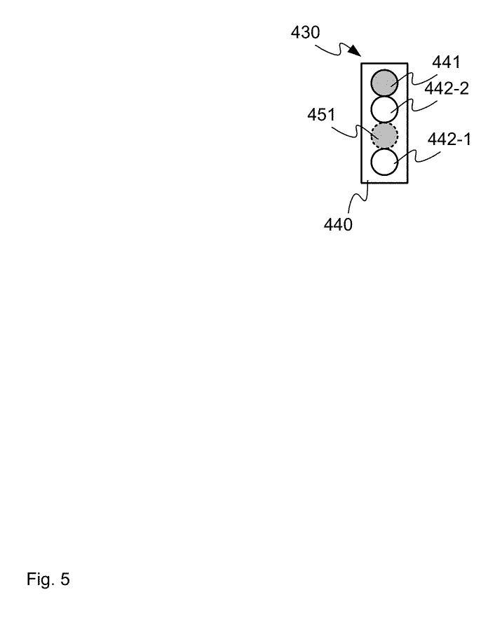

For example, attention is next directed to FIG. 4 and FIG. 5 which respectively depict a schematic side view diagram of a device 400, and a front-surface view of a mirror 430 the device 400. FIG. 4 is similar to FIG. 2 with like elements having like numbers. Indeed, the device 400 includes the laser device 200 as described above, the mirror 430 of the device 400 has similar functionality to the mirror 230, and the mirror 430 is positioned relative to the laser device 200 in a manner similar to the mirror 230. The mirror 430 hence includes a transparent body 431 that is transparent at least to the second laser beam 212, similar to the transparent body 231.

However, as is apparent from both FIG. 4 and FIG. 5, in contrast to the mirror 230, a front surface 440 of the transparent body 431 includes a front reflective region 441 that is circular in shape and is centered on a point where the first laser beam 211 interacts with the front surface 440. Similarly, a front transmissive region includes a first AR coating 442-1 that is circular in shape and is centered on a point where the second laser beam 212 enters the transparent body 431; and the front transmissive region further includes a second AR coating 442-2 that is circular in shape and is centered on a point where the second laser beam 212 exits the transparent body 431, for example after reflection from a rear reflective region 451 located on a rear surface 450. Hence, the front transmissive region comprises a first AR coating 441-1 and a second AR coating 441-1, each located in a region where the second laser beam 212 respectively enters and exits the transparent body 431.

The rear reflective region 451 is also circular in shape and is centered on a point where the second laser beam 212 interacts with the rear surface 450. In FIG. 5, the rear reflective region 451 is drawn in broken lines to indicate that the rear reflective region is located at the rear surface 450, while the front transmissive region 441, and the AR coatings 442-1, 442-1 are drawn in solid lines to indicate that they are located at the front surface 440.

Indeed, in either of the devices 200, 400, the front reflective region, the rear reflective region, and the front transmissive region may be any respective shape that results in the laser beams 211, 212 being reflected as described herein, for example to compensate for the two laser beams being not exactly parallel and/or divergent, and/or the laser beams having an angular spread and/or etendue.

Similarly, the mirrors 230, 430 may be any respective shape where the front reflective region, the rear reflective region, and the front transmissive region may be positioned relative to the laser device 200 such that the laser beams 211, 212 are reflected as described herein. Indeed, as depicted, the mirror 430 also includes a grip 498 for positioning.

However, in other implementations, the grip 298 and/or the grip 498 is optional and positions of the mirrors 230, 430 are fixed relative to the device 200, for example in a respective LOS.

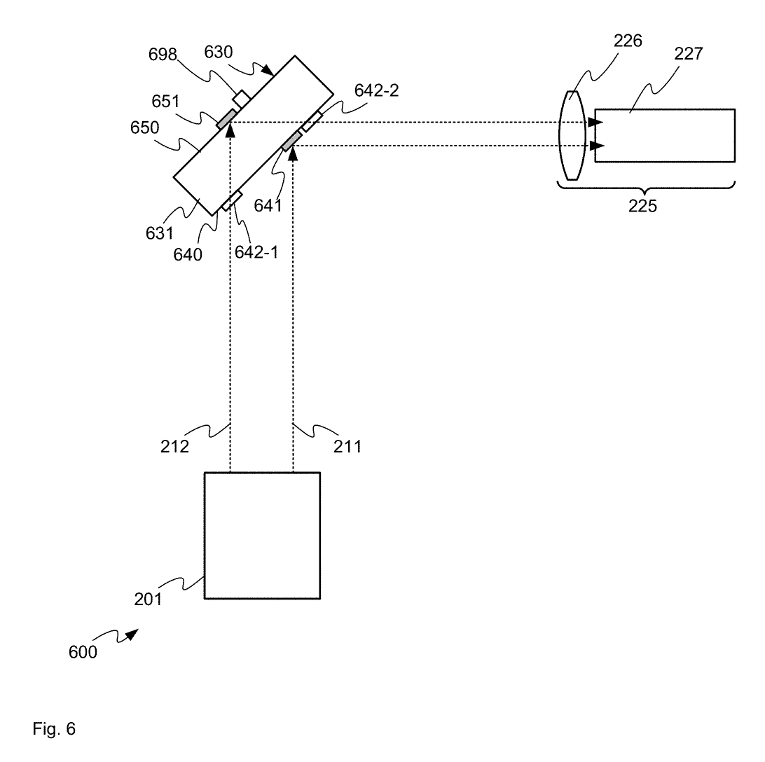

Yet further implementations are within the scope of the present specification. For example, attention is next directed to FIG. 6 which depicts a schematic side view diagram of a device 600. FIG. 6 is similar to FIG. 2 with like elements having like numbers. Indeed, the device 600 includes the laser device 200 as described above, and a mirror 630 of the device 600 has similar functionality to the mirror 430, with the mirror 630 is positioned relative to the laser device 200 in a manner similar to the mirror 230. The mirror 630 hence includes a transparent body 631 that is transparent at least to the second laser beam 212, similar to the transparent body 431.

However, as is apparent from FIG. 6, the transparent body 631 is thicker than the transparent body 231 (and/or the transparent body 431) such that the second laser beam 212 is reflected on a side opposite the first laser beam 211, as compared to the mirror 430. Similar to the mirror 430, a front surface 640 of the transparent body 631 includes a front reflective region 641 that is circular in shape (and/or any other shape as described above with reference to the front reflective region 441) and is centered on a point where the first laser beam 211 interacts with the front surface 640. Similarly, a front transmissive region includes a first AR coating 642-1 that is circular in shape and is centered on a point where the second laser beam 212 enters the transparent body 631.

However, the front transmissive region further includes a second AR coating 642-2 that is circular in shape and is centered on a point where the second laser beam 212 exits the transparent body 631, on a side of the front reflective region 641 opposite that of the first AR coating 642-1, for example after reflection from a rear reflective region 651 located on a rear surface 650.

Hence, the front transmissive region comprises a first AR coating 641-1 and a second AR coating 641-1, each located in a region where the second laser beam 212 respectively enters and exits the transparent body 631. However, the transparent body 631 is of a thickness that causes the second laser beam 212 to travel past the front reflective region 641.

Hence, when at least the front reflective region 641 is of a limited area (e.g. covers an area of the front surface 640 around a point where the first laser beam 211 reflects therefrom), and does not otherwise extend beyond an area for reflecting the first laser beam 211, the transparent body 631 can be made thicker relative to the mirror 230 providing more flexibility in selecting a thickness of the transparent body 631 (and/or the transparent body 431) as compared to the mirror 230. For example, in the device 600, assuming the mirror 630 is at a 45° to the laser device 200, the front transmissive region is bifurcated between: a first transmissive region (e.g. that includes the first AR coating 642-1) closer to the laser device 200 than the front reflective region 641; and a second transmissive region (e.g. that includes the second AR coating 642-2) further from the laser device 200 than the front reflective region 641. In contrast, in the devices 200, 400, the respective front reflective regions are not bifurcated and located closer to the laser device 200 than a respective front reflective region.

As depicted, the mirror 630 also includes an optional grip 698 for positioning, similar to the grip 298 and/or the grip 498.

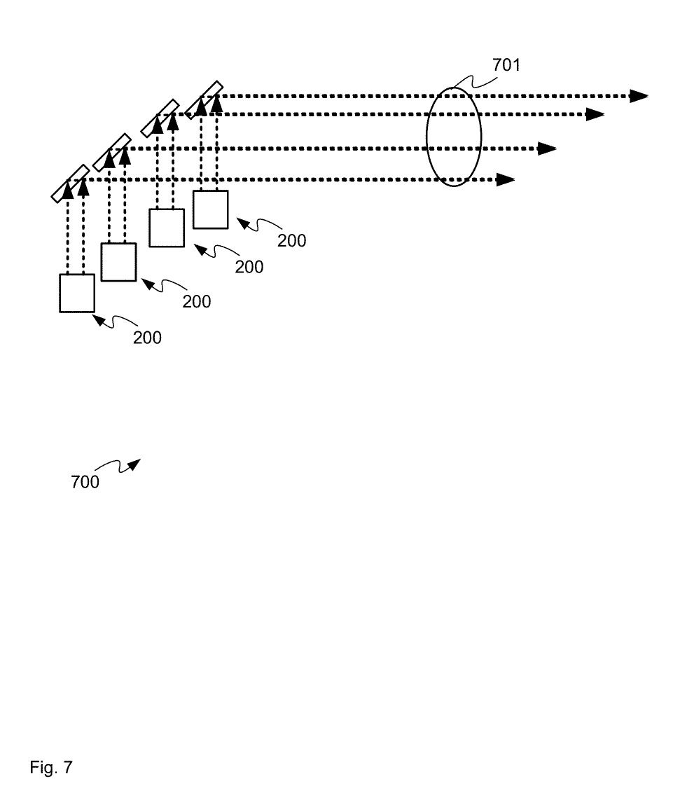

Furthermore, a plurality of the devices 200 (and/or the devices 400 and/or the devices 600) may be assembled into a single LOS and/or laser assembly. For example, attention is next directed to FIG. 7 which depicts a device 700 comprising a plurality of the devices 200 arranged so that their respective laser beams, indicated by broken lines, are generally parallel. Each of the devices 200 are offset from each other such that respective components thereof do not block laser beams of the other devices 200.

Furthermore, as the physical footprint of the devices 200 are smaller than the physical footprint of the device 100, the devices 200 may be placed close together than if the device 700 were assembled from the devices 100. Similarly, the respective laser beams of each of the devices 200 exit each device 200 with a reduced distance therebetween as compared to the device 100.

Hence, the laser beams of the devices 200, when assembled into the device 700, are within a given spot size 701, which can be smaller than a spot size produced by a similar device assembled using a plurality of the device 100. The device 700 may comprise an LOS and/or a laser assembly used with a projector, and hence images produced by such a projector may be better in quality due to the relative reduced spot size 701 (e.g. as compared to images produced by a projector that relies on light from a plurality of the devices 100, for example reduced artifacts and/or hotspots and/or irregularities in projected images). It is appreciated that the device 700 may be used in a projector with other devices which produce light of other colors such that RGB (red-green-blue) images may be produced by the projector.

Provided herein is a device for compacting dual laser beams that relies on a mirror that includes a transparent body having a front surface and a back surface. Reflecting and transmissive regions are arranged on the front surface and the back surface such that a first laser beam reflects from the front surface and a second laser beam reflects from the rear surface. A thickness of the transparent body is selected, in conjunction with an angle the mirror forms with the laser beams, to reduce a distance between the laser beams upon reflection.

Persons skilled in the art will appreciate that there are yet more alternative implementations and modifications possible, and that the above examples are only illustrations of one or more implementations. The scope, therefore, is only to be limited by the claims appended hereto.

1. A device comprising:
a laser device configured to emit a first laser beam and a second laser beam, about parallel to the first laser beam, the first laser beam and the second laser beam emitted in a first direction; and
a mirror comprising a transparent body including: a front surface including a front reflective region and at least one front transmissive region; and a rear surface about parallel to the front surface, the rear surface comprising a rear reflective region,
the front reflective region, the at least one front transmissive region and the rear reflective region arranged, relative to the laser device such that:
the front reflective region is configured to reflect the first laser beam from the front surface in a second direction, the front reflective region being centered on a first reflection point where the first laser beam interacts with the front surface,
the at least one front transmissive region is configured to transmit the second laser beam therethrough, and
the rear reflective region is configured to reflect the second laser beam, as transmitted through the at least one front transmissive region, back through the at least one front transmissive region in the second direction, the rear reflective region being centered on a second reflection point where the second laser beam interacts with the rear surface.

2. The device of claim 1, wherein the mirror is at about 45° relative to respective paths of each of the first laser beam and the second laser beam, the at least one front transmissive region is closer to the laser device than the front reflective region, and t<
$$d \sqrt{{n}^{2} - \frac{1}{2}} ,$$
where t is a thickness of the transparent body, n is an index of refraction of the transparent body, and d is a perpendicular distance between the first laser beam and the second laser beam.

3. The device of claim 1, wherein the at least one front transmissive region includes at least one anti-reflective coating.

4. The device of claim 1, wherein the front reflective region includes a reflective coating.

5. The device of claim 1, wherein the rear reflective region includes a reflective coating.

6. The device of claim 1, wherein the front reflective region, the at least one front transmissive region, and the rear reflective region are further configured to reflect the second laser beam back through the at least one front transmissive region adjacent the front reflective region.

7. The device of claim 1, wherein the front reflective region and the at least one front transmissive region are further configured to reflect the first laser beam adjacent the at least one front transmissive region.

8. The device of claim 1, wherein the at least one front transmissive region includes a first anti-reflective coating centered on a first transmission point where the second laser beam enters the transparent body and a second anti-reflective coating centered on a second transmission point where the second laser beam exits the transparent body.

9. The device of claim 1, wherein the at least one front transmissive region is located closer to the laser device than the front reflective region.

10. The device of claim 1, wherein the at least one front transmissive region is bifurcated between a first transmissive region closer to the laser device than the front reflective region and a second transmissive region further from the laser device than the front reflective region.
